(19) United States
(12) Patent Application Publication
(10) Pub. No.: US 2021/0283934 A1
(43) Pub. Date: Sep. 16, 2021

(54) METHOD OF PRINTING A BIOSENSOR PLATFORM

(71) Applicant: Swansea University

(72) Inventors: Kar Seng Teng, Swansea (GB); Jonathan Lloyd, Swansea (GB); Davide Deganello, Swansea (GB)

(73) Assignee: Swansea University, Swansea (GB)

(21) Appl. No.: 16/317,804

(22) PCT Filed: Jul. 13, 2017
(86) PCT No.: PCT/GB2017/052067

§ 371 Date: Jan. 14, 2019

(30) Foreign Application Priority Data
Jul. 15, 2016 (GB) 1612292.1

(51) Int. Cl. B41M 3/00; G01N 27/327; B41M 1/04; G01N 27/414; B41M 7/00

(52) U.S. Cl. CPC B41M 3/006; G01N 27/327; B41M 7/009; G01N 27/4145; B41M 1/04

(57) ABSTRACT

The present invention relates to a platform that may be utilised in the field of biosensors. According to the present invention there is a method of manufacturing a platform for use in bio-sensing applications comprising the steps of:
a) providing a substrate having electrodes thereon;
b) performing an overprinting step by overprinting the electrodes with a precursor solution;
c) performing a drying step to dry the precursor solution to form a print layer on the electrodes;
d) performing a further overprinting step by overprinting the print layer with a precursor solution to increase the print layer thickness;
e) performing a transformation step to at least partially transform the print layer from a first substance to a second substance different to the first substance.

The present invention relates to a platform that may be utilised in the field of biosensors.

Metal oxide semi-conductors have been successfully used in bio-sensing applications as they have quick response times and high sensitivity when compared with other sensing materials. Utilising metal oxide nanostructures improves the performance of biosensors as they exhibit a large surface area to volume ratio, good electron mobility and biocompatibility. For example, native hydroxyl groups which form on the surface of the metal oxide offer an opportunity for covalent bonding with siloxanes allowing robust attachment of bio-receptors for the detection of diseases. Such covalent functionalisation also inhibits decomposition of the metal oxide in aqueous solutions. Accordingly, metal oxide nanostructures provide high suitability for bio-sensing applications.

Thin films of metal oxide have been deposited onto substrates using techniques such as chemical vapour deposition, physical vapour deposition and molecular beam epitaxy. However, these techniques are expensive, time consuming and require complex processing steps. Hence, they are not ideal for low cost mass production of biosensors that can be potentially used for large scale screening of diseases due to the high associated cost. Accordingly, a low cost, high yield manufacturing technique for the fabrication of a biosensor platform is highly desirable.

According to the present invention there is a method of manufacturing a platform for use in bio-sensing applications comprising the steps of:
a) providing a substrate having electrodes thereon;
b) performing an overprinting step by overprinting the electrodes with a precursor solution;
c) performing a drying step to dry the precursor solution to form a print layer on the electrodes;
d) performing a further overprinting step by overprinting the print layer with a precursor solution to increase the print layer thickness;
e) performing a transformation step to at least partially transform the print layer from a first substance to a second substance different to the first substance.

The present invention allows the production of nanoscopic structures ideal for attachment of bio-receptors thus providing an effective platform for use in bio-sensing applications. Complicated post-treatment or processing techniques are not required meaning that such platforms can be produced at high speed and low cost.

The substrate may be an organic substrate, for example a polymer such as polyimide (PI) which is low cost and readily available.

The electrodes are preferably printed, preferably via flexographic printing, onto the substrate. The electrodes may be printed utilising ink, which may be silver (Ag) ink. The electrodes are preferably interdigitated.

The precursor is preferably dried to form a substantially solid print layer. This ensures overprinting does not smudge a previous print layer.

The precursor composition preferably comprises a first substance selected to form a second substance comprising metal oxide during the transformation step. Accordingly, as an example only the precursor composition may comprise a metal acetate, preferably comprising a zinc acetate. Upon transformation therefore, the precursor transforms into a metal oxide, preferably zinc oxide. Zinc oxide is a preferred metal oxide nanostructure as is known to provide hydroxyl groups on the surface of the zinc oxide allowing strong covalent bonding with siloxanes allowing robust attachment of bio-receptors for the detection of diseases and inhibition of decomposition of the zinc oxide in aqueous solution. Furthermore, it possesses good electrochemical properties.

It will be appreciated that some transformation of the precursor occurs during the drying step. The majority of the print layer is preferably transformed during the transformation step.

The drying step beneficially comprises the application of heat and the heating temperature is preferably in the range of 50-250° C., and is preferably for a time period of less than 1 minute. Even more preferably, the drying temperature range is between 100-200° C. and the time period is between 20-40 seconds. It has been found that a drying temperature of substantially 150° C. for 30 seconds provides a beneficial drying step for at least partially transforming the precursor solution to form a coating on the electrodes.

The method may further comprise after step (d) performing further steps of drying the precursor solution and overprinting with precursor solution in sequence one or more times to increase the print layer thickness. Thus, layers of print material may be built up through overprinting and subsequent heating. The process may be repeated to form multiple layers. The number of layers is preferably three or more, and is preferably less than 10, more preferably six layer.

It will thus be appreciated that the drying step and overprinting with precursor solution may be repeated one or more times. It will also be appreciated that each drying step may comprise different drying parameters.

Also, other techniques such as ultra-violet or near infrared illuminations can be used to provide drying steps as they would induce heating at the printed layers.

The transformation step is beneficial as it effectively provides an annealing step which ensures the conversion of the first substance which is predominantly precursor to metal oxide is maximised. The drying step will cause some transformation however this is maximised by the transformation step. Furthermore, this transformation step ensures a polycrystalline structure and effectively removes the interruption or appearance of a layered metal oxide structure. The result is a nanotextured metal oxide surface ideal for high volume loading of bio-receptors.

The transformation step preferably comprises a heat treatment. The heat treatment is preferably for a longer time period and preferably at a higher temperature than the drying step(s). This is to allow full conversion of the precursor into metal oxide and interconnection of metal oxide nanoparticles with a size of a few nanometres.

The heat treatment preferably lasts longer than 10 minutes, preferably longer than 20 minutes, and preferably lasts approximately 30 minutes. The temperature of the heat treatment in the second transform protocol may be at a temperature of greater than 200° C., and is preferably at approximately 300° C.

A drying step is preferably completed prior to the transformation step. Whilst it will be appreciated that following overprinting drying may also be achieved utilising the transformation step, in order to maximise effectiveness of the process and also manufacturing ease a drying step should be included.

Overprinting is preferably performed by flexographic printing and wherein the electrodes are also printed onto the substrate.

The precursor is preferably overprinted to provide the print layer thickness for overprinting step of less than 500 nm, preferably less than 100 nm and preferably less than 60 nm.

The present invention also extends to a bio-sensing platform manufactured according to the present invention.

The present invention also extends to a method of manufacturing a biosensor comprising manufacturing a biosensor platform as hereinbefore described and functionalising with a biological molecule.

Aspects of the present invention will now be described by way of example only with reference to the accompanying figures in which:

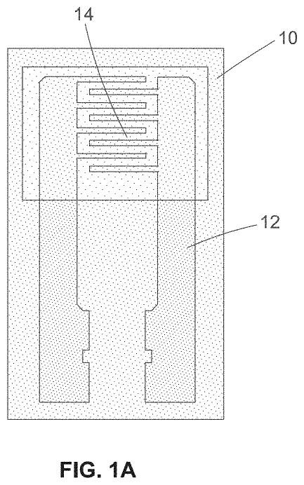

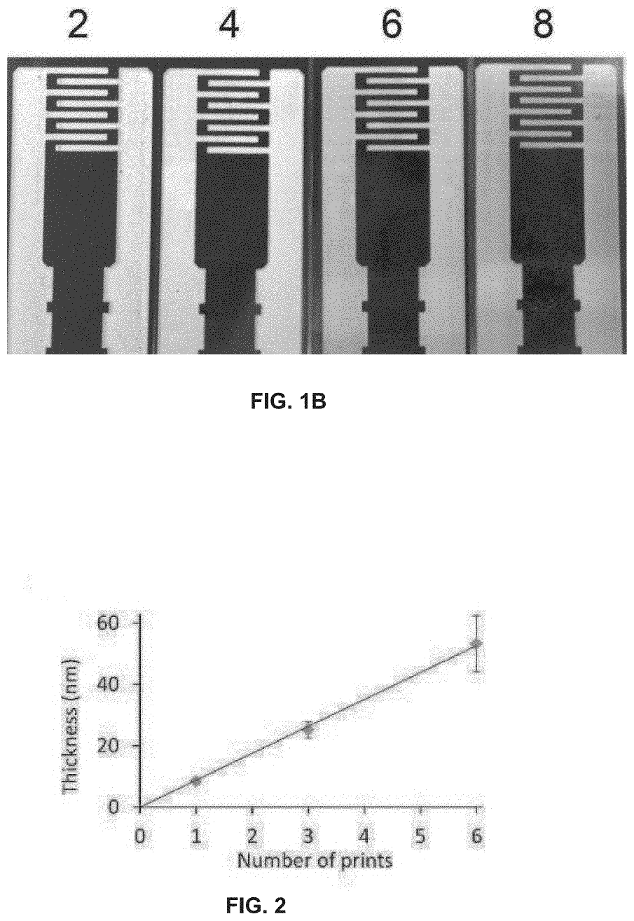

FIG. 1(a) is a schematic representation of the biosensor with printed ZnO at the interdigitated electrodes on a substrate. FIG. 1(b) shows four biosensors with different number of precursor overprints.

FIG. 2 is a graphical representation of the thickness of the coating based on the number of overprints.

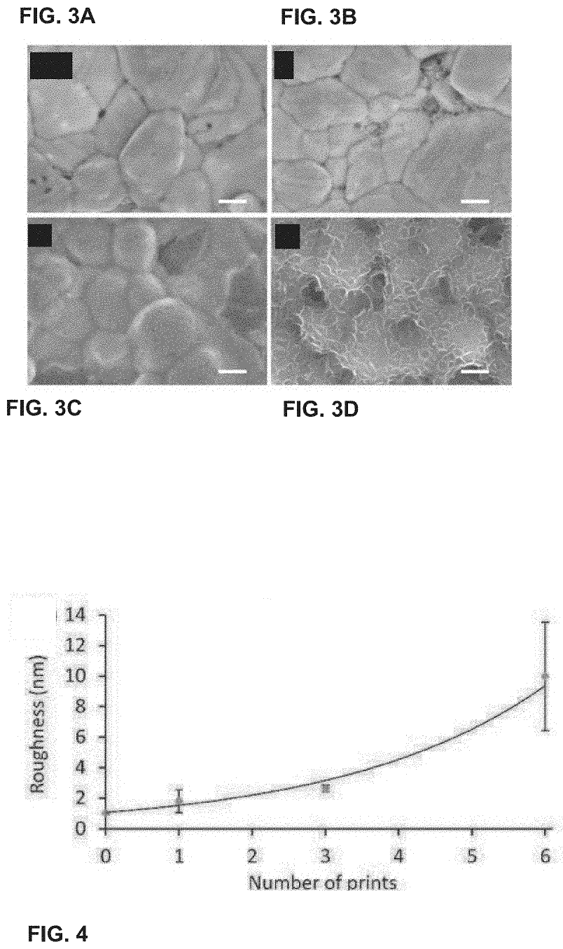

FIG. 3 is a magnified morphological analysis of the upper surface of a platform according to an exemplary embodiment of the present invention and is presented as (i) bare silver electrode, (ii) one printed layer, (iii) three printed layers and (iv) six printed layers where the scale bar is 300 nm.

FIG. 4 is a graphical representation of the service roughness of the coating dependent upon the number of overprints.

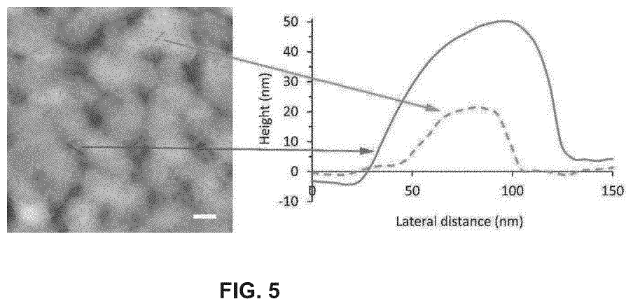

FIG. 5 is a surface morphology analysis of a zinc oxide coating on a silver electrode magnified such that the scale bar is representative of 300 nm and indicated line profiles show the height of the coating on top of the silver particles in the dashed line and in the low regions of the silver electrode surface as shown in the blue solid line.

The steps of manufacturing a platform according to an exemplary embodiment are outlined below.

An organic substrate such as polyimide (PI) 10 is provided and cleaned ready for electrode printing. A suitable printing material is silver ink which can be printed, preferably via flexographic printing, onto the substrate. The ink is placed onto an anilox roller that transfers a controlled volume of ink to the printing plate which subsequently prints the desired electrode pattern 12 onto the substrate. The electrode pattern is preferably an interdigitated pattern of electrodes as shown in FIG. 1b which presents four bio-sensing platforms having zero, one, three and six overprints thereon as indicated by reference numerals 2, 4, 6 and 8 respectively. Optimised parameters for printing the silver ink are summarised below in table 1. After printing silver electrodes the samples are dried and the silver ink may be sintered by an annealing process.

The precursor, which in the exemplary embodiment will be referred to as zinc acetate, is then printed over the top of the electrodes again using the optimised parameters summarised in table 1. A plurality of layers of precursor solution may be printed over the electrodes with a drying step in between each printing step to dry the print layer before subsequent printing of another layer. Immediately after printing the drying step is completed at an elevated temperature such as 150° C. for approximately 30 seconds to dry the precursor before printing the next layer. A degree of transformation of the drying precursor will occur to form a metal oxide.

A transformation step is carried out after the final overprinting layer to ensure maximised conversion of zinc acetate to zinc oxide. This process of the transformation step may comprise placing the platform in an oven at approximately 300° C. for 30 minutes to allow full conversion of the zinc acetate to zinc oxide. This process leads to a nanotextured zinc oxide surface ideal for high loading of bioreceptors.

| | Ag Ink | ZnA Ink |
|---|---|---|
| Anilox roller volume | 8 cm³m⁻² | 12 cm³m⁻² |
| Anilox force | 50N | 125N |
| Printing force | 50N | 150N |
| Printing speed | 0.8 ms⁻¹ | 0.2 ms⁻¹ |

The transformation step comprises a different protocol to the drying step, and preferably comprises a heat treatment process. This is to ensure full conversion of the zinc acetate to zinc oxide. It will also be appreciated that the transformation step may follow after a drying step, or directly after a precursor over printing step, however for manufacturing ease the transformation step will follow a drying step.

The transformation step is important as thermal decomposition of zinc acetate will form zinc oxide 14. A temperature of 300° C., which is 50° C. less than the glass transition temperature of the substrate (PI) is desirable. The transform protocol may comprise maintaining at a temperature of approximately 300° C. for 30 minutes. It will be appreciated that the annealing time in the transformation step may be reduced to well below 30 minutes, however it has been determined that 30 minutes maximises the effect of transformation from zinc acetate to zinc oxide.

Referring to FIG. 2 it is preferred that a plurality of overprinting steps are carried out to add additional precursor solution to increase the thickness of the print layer. Printing can achieve roughly linear deposition and each printed layer is less than 500 nm, preferably less than 100 nm and even more preferably less than 60 nm. This is readily achievable using flexographic printing. Each printed layer of precursor and after subsequent drying adds approximately 7-10 nm to the total thickness of the zinc oxide structure.

The printed zinc acetate layers followed by thermal decomposition results in a polycrystalline zinc oxide coating. Scanning electron microscope (SEM) images shown in FIG. 3 illustrate that the resultant zinc oxide layer, after the transformation step, is made of many interconnected zinc oxide particles with a size of a few nanometres. It is important that the resultant coating of zinc oxide is polycrystalline and after the transformation step it is difficult to distinguish between the individual layers. Referring to FIG. 3(i) the bare silver electrode is shown showing the submicron grains. The subsequent images show the density of the nanoparticles on the surface of the silver grains increasing with increasing number of overprint steps. For a single overprint onto the silver electrode as shown in FIG. 3(u) it can be seen that the density of the nanoparticles is non-uniform with a lower density in the higher regions of silver and a higher density in the troughs. Thus, non-uniform zinc oxide nanoparticles on the rough silver electrode surface is shown. As shown in FIG. 3(iii) the number of overprint layers has increased to three and as shown in FIG. 3(iv) the surface is shown after six overprint layers. As can be seen after six prints, aggregated zinc oxide nanoparticles can be seen across the entire silver electrode.

It is beneficial that the surface is rougher to provide increased surface area in order to increase the number of bio-receptors attaching at the surface.

FIG. 4 represents a graphical representation of the surface roughness against the number of overprint steps. FIG. 5 is an atomic force microscope image of surface morphology of the zinc oxide structure and indicated line profile shows the height of the structures on the top of the silver particle as a dashed line and in the lower regions of the silver surface in the solid line. This provides an extremely good surface for bio-receptor attachment. The height was found to vary between the high and low regions of the submicron grains of silver which can be attributed to the pooling of ink on the low regions and also the low regions experiencing reduced contact with the printing plate. The formation of these nanotextured features may occur during the drying step of the precursor between each subsequent print. The evaporation of liquid occurs more readily at points of surface imperfection. These points of evaporation will induce Marangoni flow creating a high point in the surface after drying due to the mass flow of the zinc acetate precursor to the area of evaporation. These surface imperfections may encourage evaporation at the same point in the subsequent printed layers. In this way, the phenomenon will increase the size of these nanotextured features with further print and dry cycles. The sensitivity of the biosensors may thus be enhanced. It is preferred as presented that approximately six overprinting stages are carried out.

As the nanotextured surface features are larger than the antibody, improved surface area allows more antibodies to attach to the surface. With the formation of this low cost mass producible metal oxide (zinc oxide) layer suitable for biosensing, a high volume low cost method of manufacturing a platform for use in biosensing applications is achieved.

The present invention has been described by way of example only and it will be appreciated to the skilled addressee that modifications and variations may be made without departing from the scope of protection afforded by the appended claims.

1. A method of manufacturing a platform for use in bio-sensing applications, comprising:
a) providing a substrate having electrodes thereon;
b) performing an overprinting step by overprinting the electrodes with a precursor solution;
c) performing a drying step to dry the precursor solution to form a print layer on the electrodes;
d) performing a further overprinting step by overprinting the print layer with the precursor solution to increase print layer thickness; and
e) performing a transformation step to at least partially transform the print layer from a first substance to a second substance different to the first substance.

2. The method according to claim 1, wherein the drying step comprises application of heat.

3. The method according to claim 2 wherein the application of heat comprises heating to a temperature in the range of 50-250° C., for a time period of less than 1 minute.

4. The method according to claim 3, wherein the heating temperature range is between 100-200° C. and the time period is between 20-40 seconds.

5. The method according to claim 1, comprising after step (d) performing further steps of drying the precursor solution and further overprinting with the precursor solution in sequence one or more times to increase the print layer thickness.

6. The method according to claim 1, wherein the transformation step comprises a heat treatment.

7. The method according to claim 6, wherein the heat treatment is for a longer time period at a higher temperature than the drying step.

8. The method according to claim 7, wherein the heat treatment lasts greater than 10 minutes.

9. The method according to claim 8, wherein the heat treatment is at a temperature of greater than 200° C.

10. The method according to claim 1, further comprising a drying step after step d) before the transformation step.

11. The method according to claim 1, wherein the precursor composition is selected to form a solid metal oxide coating during the transformation step.

12. The method according to claim 11, wherein the precursor composition comprises a metal acetate.

13. The method according to claim 1, wherein overprinting is performed by flexographic printing.

14. The method according to claim 1, wherein the electrodes are printed onto the substrate.

15. The method according to claim 1, wherein the precursor solution is overprinted to provide the print layer thickness for each overprinting step of less than 500 nm.

16. A biosensing platform manufactured according to claim 1.

17. The method of manufacturing a biosensor comprising manufacturing a biosensor platform according to claim 1, and functionalising with a biological molecule.

18. The method according to claim 8, wherein the heat treatment lasts approximately 30 minutes.

19. The method according to claim 9, wherein the heat treatment is at a temperature of approximately 300° C.

20. The method according to claim 12, wherein the precursor composition comprises zinc acetate.
